(19) United States
(12) Patent Application Publication
(10) Pub. No.: US 2006/0211554 A1
(43) Pub. Date: Sep. 21, 2006

(54) Tool magazine assembly for a machining center

(76) Inventor: Hsin-Jung Liu, Taichung Hsien (TW)

Correspondence Address: HERSHKOVITZ & ASSOCIATES, 1725 I STREET NW, SUITE 300, WASHINGTON, DC, 20006, US

(21) Appl. No.: 11/083,220

(22) Filed: Mar. 18, 2005

(51) Int. Cl. B23Q 3/157

(52) U.S. Cl. 483/67

(57) ABSTRACT

A tool magazine assembly for a machining center holds multiple tool holders and has an outer ring, an inner ring and multiple brackets. The inner ring is mounted in but does not contact the outer ring and has multiple through holes. The brackets are attached to the inner ring, and each bracket has multiple through holes, a central hole, multiple fastening holes, multiple bolts and a central bolt. The bolts extend through the through holes to attach the brackets to the inner ring. The central bolts extend through the central holes between the inner ring and the outer ring. Each tool holder has multiple bolts. The bolts extend through the fastening holes to attach the tool holders to the brackets.

### BACKGROUND OF THE INVENTION

1. Field of the Invention

The present invention relates to tool magazine assembly, especially to a tool magazine assembly for a machining center.

2. Description of the Prior Arts

A machining center is a machine that can cut, drill, bore, mill, etc. With reference to FIGS. 12 and 13, the machining center has a conventional tool magazine assembly (60) to hold multiple tool holders (61). The conventional tool magazine assembly (60) comprises two curved channels (70), a central disk (62), multiple brackets (63) and multiple bolts (64). The curved channels (70) are mounted on opposite sides of the machining center, and each channel (70) has a bottom end. The bottom ends of the channels (70) are separated from each other by a gap (71). The central disk (62) is mounted in the machining center between the channels (70) and has a circular edge. The brackets (63) are mounted securely on the circular edge of the central disk (62). The bolts extend through the circular edge of the central disk (62) and the brackets (63) to attach the brackets (63) to the central disk (62). The tool holders (61) are attached respectively to the brackets (63) and selectively slide in the channels (70). Each tool holder (61) has a tool mounted in the tool holder (61). When one of the tools has to be changed, the tool holder (61) must be positioned in the gap (71). A motor rotates the central disk (62), and the tool holders (61) slide along the channels (70).

However, the conventional tool magazine assembly (60) has numerous shortcomings that include the following.

1. Multiple through holes have to be formed in the central disk (62) and the brackets (63) so the bolts (64) can extend through the through holes. Because the through holes in the central disk (62) must correspond to the through holes in the brackets (63), forming the through holes is not easy.

2. Because the channels (70) are huge, the channels (70) cost a lot and mounting the channels (70) in the machining center is complicated.

3. Because the tool holders (61) do not individually rotate but slide on the channels (70), the tool holders (61) rub against the channels (70) and cause the motor to vibrate easily. The vibration of the motor generates loud noises and adds significantly to the load on the motor. Furthermore, the friction between the tool holders (61) and the channels (70) and the vibration of the motor shorten the life of the tool holders (61), the channels (70) and the motor.

To overcome the shortcomings, the present invention provides an improved tool magazine assembly for a machining center to mitigate or obviate the aforementioned problems.

### SUMMARY OF THE INVENTION

The main objective of the present invention is to provide a tool magazine assembly for a machining center that is less expensive, has a longer life and rotates smoothly. The tool magazine assembly for a machining center holds multiple tool holders and has an outer ring, an inner ring and multiple brackets. The inner ring is mounted in and separate from the outer ring and has multiple through holes. The brackets are attached to the inner ring, and each bracket has multiple through holes, a central hole, multiple fastening holes, multiple bolts and a central bolt. The bolts extend through the through holes to attach the brackets to the inner ring. The central bolts extend through the central holes between the inner ring and the outer ring. Each tool holder has multiple bolts. The bolts extend through the fastening holes to attach the tool holders to the brackets.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a tool magazine assembly for a machining center in accordance with the present invention with multiple tool holders;

FIG. 2 is an exploded perspective view of the tool magazine assembly in FIG. 1 with a tool holder;

FIG. 3 is a front view of the tool magazine assembly in FIG. 1 with two tool holders;

FIG. 4 is a top view in partial section of the tool magazine assembly in FIG. 1 with two tool holders;

FIG. 5 is a front view of a second embodiment of a tool magazine assembly for a machining center in accordance with the present invention with two tool holders;

FIG. 6 is a top view in partial section of the tool magazine assembly in FIG. 5 with two tool holders;

FIG. 7 is a front view of a third embodiment of a tool magazine assembly for a machining center in accordance with the present invention with two tool holders;

FIG. 8 is a front view of a fourth embodiment of a tool magazine assembly for a machining center in accordance with the present invention with two tool holders;

FIG. 9 is a top view in partial section of the tool magazine assembly in FIG. 8 with two tool holders;

FIG. 10 is a front view of a fifth embodiment of a tool magazine assembly for a machining center in accordance with the present invention with two tool holders;

FIG. 11 is a top view in partial section of the tool magazine assembly in FIG. 10 with two tool holders;

FIG. 12 is a front view of a conventional tool magazine assembly in accordance with the prior art; and

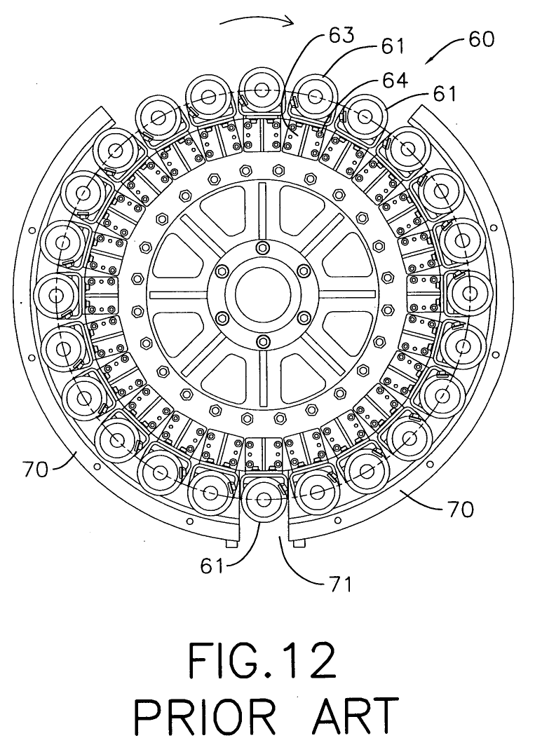

FIG. 13 is a rear view of the conventional magazine assembly in FIG. 12.

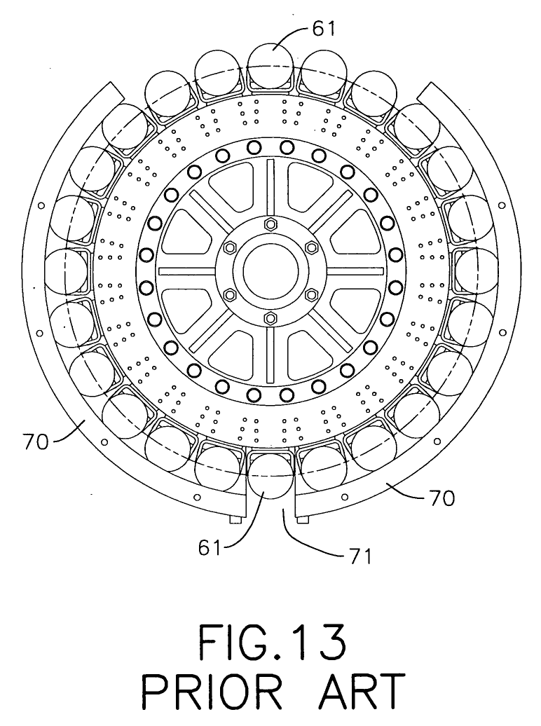

### DETAILED DESCRIPTION OF THE PREFERRED EMBODIMENTS

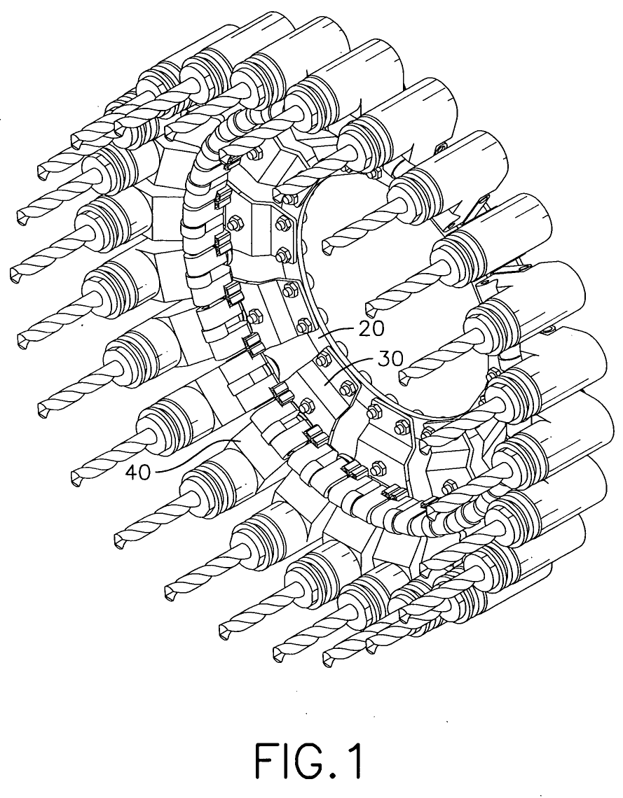

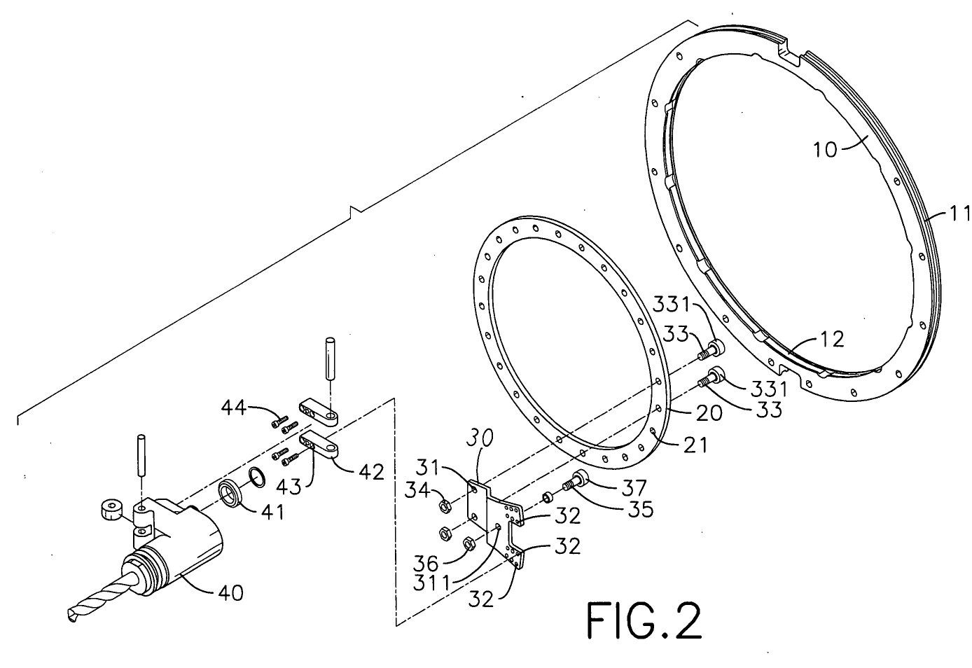

With reference to FIGS. 1, 2, 3 and 4, a tool magazine assembly for a machining center in accordance with the present invention holds multiple tool holders (40), comprises an optional mounting bracket (80), an outer ring (10), an inner ring (20), multiple brackets (30) and a motor assembly (50).

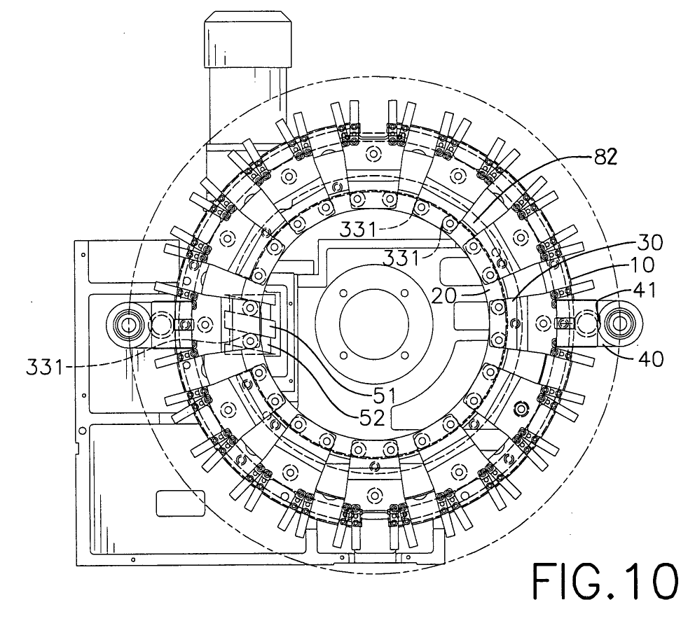

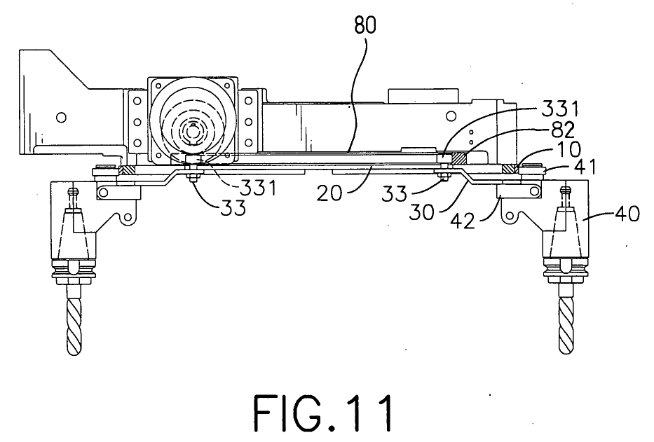

With further reference to FIGS. 10 and 11, the mounting bracket (80) has an annular shoulder (82) with an inner bearing surface.

The outer ring (10) has an outer wall, an inner wall, a front surface, an optional outer annular recess (11) and an optional inner annular recess (12). The outer annular recess (11) is formed in the outer wall. The inner annular recess (12) is formed in the inner wall.

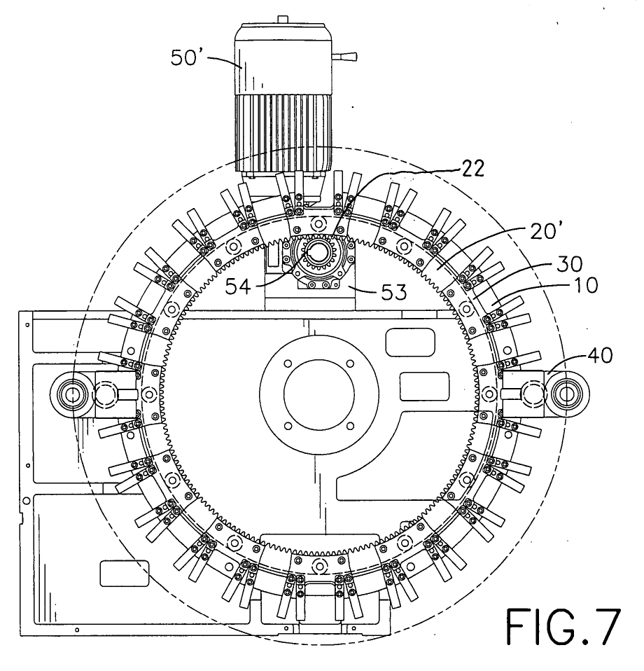

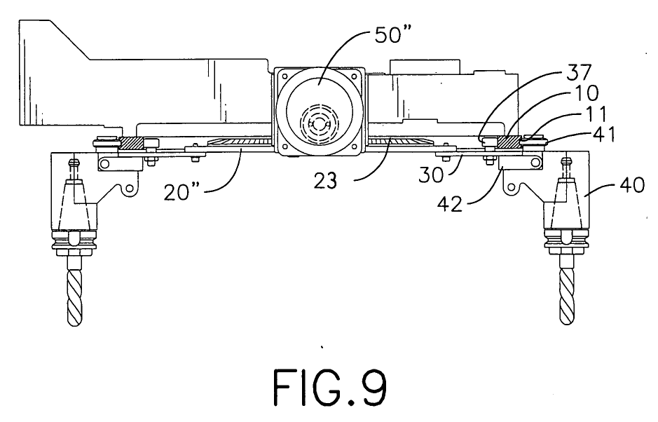

With further reference to FIGS. 7 and 9, the inner ring (20, 20′, 20″) is mounted in and is separate from the outer ring (10) and has an inner wall, an outer wall, a front surface, a rear surface, multiple through holes (21) and multiple optional teeth (22) or multiple optional beveled teeth (23). The through holes (21) are formed through the inner ring (20). The teeth (22) are formed on the inner wall. The beveled teeth (23) are formed on the rear surface.

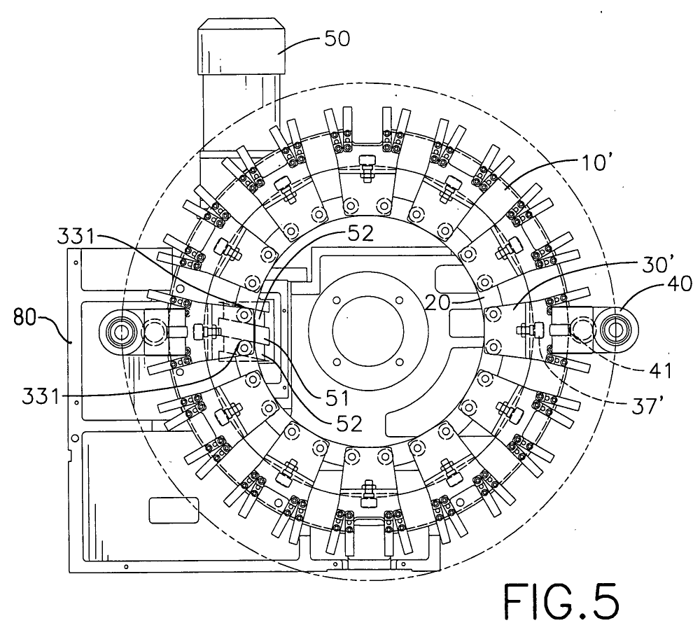

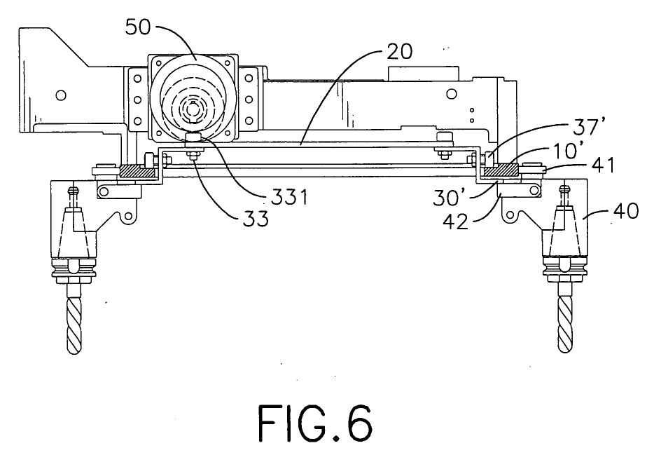

With further reference to FIGS. 5 and 6, each bracket (30, 30′) is mounted on the inner ring (20, 20′, 20″), has an inside end, an outside end, a central hole (311), a central bolt (35) and a central nut (36) and may have multiple through holes (31), multiple fastening holes (32), multiple bolts (33) and multiple nuts (34). The outside end is U-shaped. The central hole (311) is formed through the bracket (30). The central bolt (35) extends through the central hole (311) and has a threaded end, a distal end and a roller (37). The roller (37) is mounted rotatably on the distal end and rolls on the outer wall of the inner ring (20) and in the inner annular recess (12) in the inner wall of the outer ring (10) or on the front surface of the outer ring (10). The central nut (36) is screwed onto the threaded end of the central bolt (35). The through holes (31) are formed through the bracket (30) near the inside end and correspond to through holes (21) through the inner ring (20, 20′, 20″). The fastening holes (32) are formed through the bracket (30) near the outside end. The bolts (33) extend through the through holes (21, 31) in the inner ring (20, 20′, 20″) and the bracket (30) to attach the bracket (30) to the inner ring (20). Each bolt (33) has a threaded end, a distal end and an optional roller (331). The roller (331) is mounted rotatably on the distal end of the bolt (33) and may roll on the bearing surface of the annular shoulder (82). The nuts (34) are screwed respectively onto the threaded ends of the bolts (33).

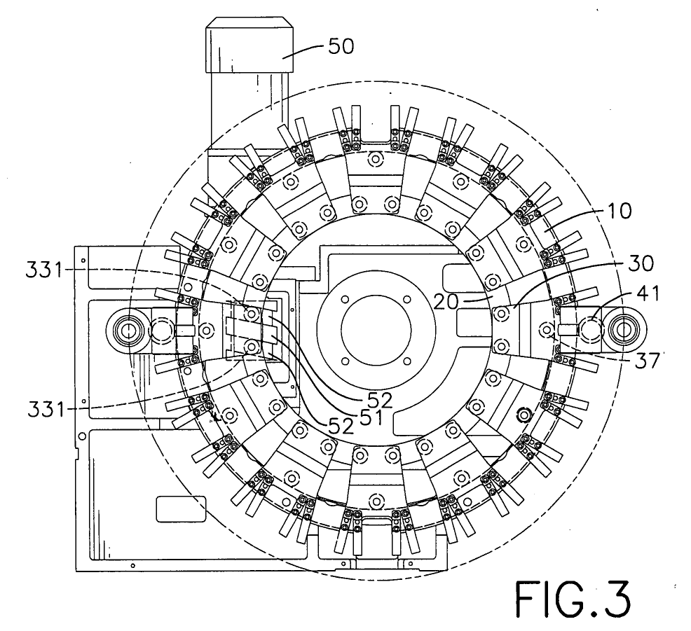

With reference to FIGS. 3, 7 and 8, the motor assembly (50) rotates the inner ring (20, 20′, 20″), has a motor and a transmission device. The transmission device connects to the motor, rotates the inner ring (20) and may comprise a worm gear (51), a reduction device (53) and a spur gear (54) or a bevel gear (56).

The worm gear (51) connects to and is rotated by the motor and has a spiral groove (52). The spiral groove (52) is formed on the worm gear (51) and engages the rollers (331) on the bolts (33) to rotate the inner ring (20).

The reduction device (53) connects to and is driven by the motor. The. spur gear (54) connects to and is driven by the reduction device (53) and engages the teeth (22) on the inner wall of the inner ring (20) to rotate the inner ring (20′).

The bevel gear (56) connects to and is driven by the motor and engages the beveled teeth (23) on the inner ring (20″) to rotate the inner ring (20″).

Each tool holder (40) has a roller (41), two hinges (42) and multiple bolts (44). The roller (41) is mounted on the tool holder (40) and rolls along the outer annular recess (11) in the outer ring (10). The hinges (42) are attached securely and adjustably to the bracket (30) and pivotally on the tool holder (40), and each hinge (42) has multiple fastening holes (43). The bolts (44) extend respectively through the fastening holes (43) and screw into the fastening holes (32) in bracket (30) to securely hold the tool holder (40) on the inner ring (20).

In a first, second and fifth embodiment of the tool magazine assembly in accordance with the present invention as shown in FIGS. 3, 4, 5, 6, 10 and 11, the motor drives the worm gear (51). The spiral groove (52) engages the rollers (331) on the bolts (33) to rotate the inner ring (20). Because the tool holders (40) are attached to the inner ring (20), the tool holders (40) rotate.

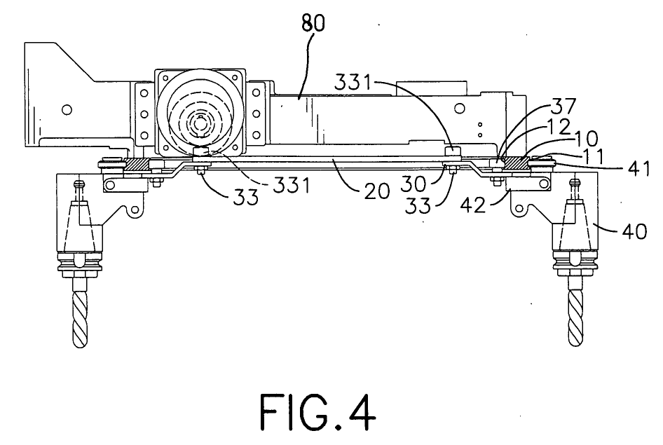

In the first embodiment as shown in FIGS. 3 and 4, the rollers (37) on the central bolts (35) roll in the inner annular recess (12) in the outer ring (10). The rollers (41) on the tool holders (40) roll in the outer annular recess (11) in the outer ring (10).

In the second embodiment as shown in FIGS. 5 and 6, the rollers (37) on the central bolts (35) roll on the rear surface of the outer ring (10). The rollers (41) on the tool holders (40) roll on the outer wall of the outer ring (10).

In the fifth embodiment as shown in FIGS. 10 and 11, the rollers (331) roll on the bearing surface inside the annular shoulder (82) on the mounting bracket (80).

In a third embodiment of the tool magazine assembly in accordance with the present invention as shown in FIG. 7, the motor drives the reduction device (53), and the reduction device (53) rotates the spur gear (54). The spur gear (54) engages the teeth (22) on the inner ring (20′) to rotate the inner ring (20′). Because the tool holders (40) are mounted on the inner ring (20′), the tool holders (40) rotate.

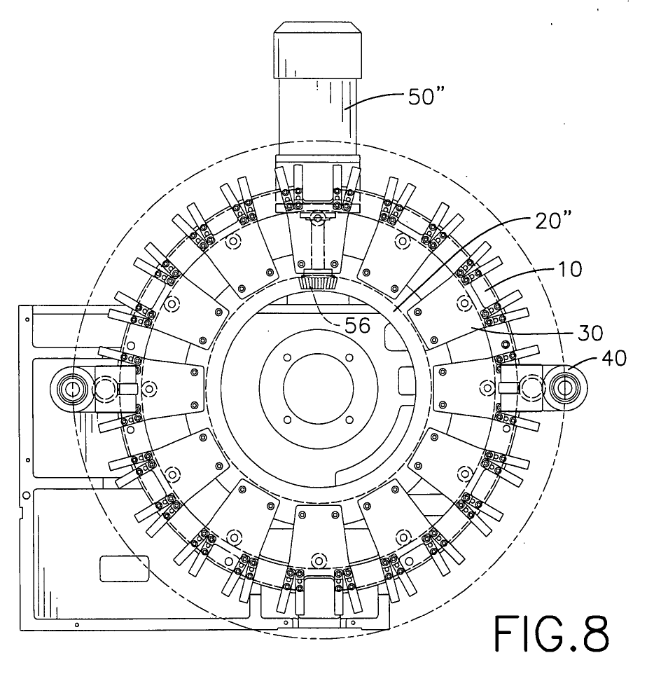

In a fourth embodiment of the tool magazine assembly in accordance with the present invention as shown in FIGS. 8 and 9, the motor rotates the bevel gear (56). The bevel gear (56) engages the longitudinal teeth (22) to rotate the inner ring (20″). Because the tool holders (40) are mounted on the inner ring (20″), the tool holders (40) rotate.

The tool magazine assembly as described has the following advantages over the conventional tool magazine assembly.

1. The components of the tool magazine assembly are simple and are easy to manufacture. The simple components cost less and reduce the total cost of the machining center.

2. The brackets (30) are easy to manufacture modularly.

3. Because the rollers (331, 37, 41) roll on the inner ring (20), the outer ring (10) and the mounting bracket (80), friction and the resultant heat, noise and wear between them is reduced, and the life of the tool magazine assembly is longer.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A tool magazine assembly for a machining center comprising
an outer ring having an outer wall, an inner wall and a front surface;
an inner ring mounted in and separate from the outer ring and having an inner wall;
an outer wall;
a front surface;
a rear surface; and
multiple through holes formed through the inner ring;
multiple brackets mounted on the inner ring, and each bracket having
an inside end;
an outside end being U-shaped;
a central hole formed through the bracket;
a central bolt extending through the central hole and having
a threaded end,
a distal end; and
a roller mounted rotatably on the distal end and rolling on the outer wall of the inner ring and the outer ring;
a central nut screwed onto the threaded end of the central bolt; and
a motor assembly rotating the inner ring and having
a motor; and
a transmission device connecting to the motor to rotate the inner ring.

2. The tool magazine assembly as claimed in claim 1, wherein
each bracket further comprises
multiple through holes formed through the bracket near the inside end and corresponding to through holes through the inner ring;
multiple fastening holes formed through the bracket near the outside end;
multiple bolts extending through the through holes in the inner ring and the bracket to attach the bracket to the inner ring, and each bolt having
a threaded end;
a distal end; and
a roller mounted rotatably on the distal end of the bolt;
multiple nuts screwed respectively onto the threaded ends of the bolts; and
the transmission device of the motor assembly comprises
a worm gear connecting to and rotated by the motor and having a spiral groove formed on the worm gear and engaging the rollers on the bolts to rotate the inner ring.

3. The tool magazine assembly as claimed in claim 2, wherein the rollers on the central bolts roll on the front surface of the outer ring.

4. The tool magazine assembly as claimed in claim 2, wherein
the outer ring further has
an outer annular recess formed in the outer wall; and
an inner annular recess formed in the inner wall; and
the rollers on the central bolts rolls in the inner annular recess in the inner wall of the outer ring.

5. The tool magazine assembly as claimed in claim 1, wherein
the inner ring further has multiple teeth formed on the inner wall; and
the transmission device of the motor assembly comprises
a reduction device connecting to and driven by the motor; and
a spur gear connecting to and driven by the reduction device and engaging the teeth on the inner wall of the inner ring.

6. The tool magazine assembly as claimed in claim 1, wherein
the inner ring further has multiple beveled teeth formed on the rear surface; and
the transmission device of the motor assembly comprises a bevel gear connecting to and driven by the motor and engaging the beveled teeth on the inner ring.

7. A tool magazine assembly for a machining center comprising
a mounting bracket having an annular shoulder with an inner bearing surface;
an outer ring having an outer wall, an inner wall and a front surface;
an inner ring mounted in and separate from the outer ring and having
an inner wall;
an outer wall;
a front surface;
a rear surface; and
multiple through holes formed through the inner ring;
multiple brackets mounted on the inner ring, and each bracket having
an inside end;
an outside end being U-shaped;
each bracket further comprises
multiple through holes formed through the bracket near the inside end and corresponding to through holes through the inner ring;
multiple fastening holes formed through the bracket near the outside end;
multiple bolts extending through the through holes in the inner ring and the bracket to attach the bracket to the inner ring, and each bolt having
a threaded end;
a distal end; and
a roller mounted rotatably on the distal end of the bolt and rolling on the bearing surface of the annular shoulder;
multiple nuts screwed respectively onto the threaded ends of the bolts; and
a motor assembly rotating the inner ring and having
a motor; and
a transmission device connecting to the motor to rotate the inner ring and having
a worm gear connecting to and rotated by the motor and having a spiral groove formed on the worm gear and engaging the rollers on the bolts to rotate the inner ring.
